(19) United States
(12) Patent Application Publication
(10) Pub. No.: US 2024/0283197 A1
(43) Pub. Date: Aug. 22, 2024

(54) SOCKETS HAVING FINE PITCH 3D FEATURES

(71) Applicant: Intel Corporation, Santa Clara, CA (US)

(72) Inventors: Saikat Mondal, Santa Clara, CA (US); Donald T. Tran, Phoenix, AZ (US); Zhichao Zhang, Chandler, AZ (US); Srikant Nekkanty, Chandler, AZ (US)

(73) Assignee: Intel Corporation, Santa Clara, CA (US)

(21) Appl. No.: 18/112,583

(22) Filed: Feb. 22, 2023

(51) Int. Cl. H01R 13/6474; H01R 13/6461

(52) U.S. Cl. CPC H01R 13/6474; H01R 13/6461

(57) ABSTRACT

An apparatus and method for fine tuning impedance in a pin arrangement of a socket are described. The socket has a socket body that contains a plurality of coupling bridges. Each coupling bridge contains: a surrounding portion that at least partially surrounds a via, and a stub portion extending from the ring-shaped portion. Pins inserted in a plurality of vias are arranged in pin pairs configured to support Double Data Rate (DDR) data signals. Each first pin of at least some of the pin pairs electromagnetically coupled to a second pin of these pin pairs using one of the coupling bridges.

### TECHNICAL FIELD

Embodiments pertain to pin sockets. In particular, some embodiments relate to pin arrangements for fine tuning impedance and crosstalk.

### BACKGROUND

The ever-increasing desire for fast performance continues to drive commensurate improvement in software and hardware in individual devices and servers. One such hardware improvement continues to be related to sockets for connecting high-speed memory such as a central processing unit (CPU) on a motherboard, that is DDR (double data rate) SDRAM (Synchronous Dynamic Random-Access Memory). The DDR data rate has grown from 0.2 8 GT/s for Gen1 PCle DDR to 6.4 GT/s for Gen5 and 16 GT/s and beyond for DDR6 end-of-life interconnects. CPU sockets currently use the same contact design throughout the socket, which can be referred to as a homogenous design. The contact is designed to meet a variety of requirements for chip connection including electrical, mechanical, density, contact reliability, safety, manufacturability and cost. A homogenous contact design is cost effective as such a designed uses a minimal number of process steps. In particular, rows of uniform contacts are stamped from a progressive die, then attached to the socket body. However, a number of design limitations are present due to the homogenous nature of the design.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various embodiments discussed in the present document.

FIG. 1 illustrates a system in accordance with some embodiments.

FIG. 2A illustrates a perspective view of a socket in accordance with some embodiments.

FIG. 2B illustrates a top view of the socket of FIG. 2A in accordance with some embodiments.

FIG. 2C illustrates a side view of the socket of FIG. 2A in accordance with some embodiments.

FIG. 2D illustrates a perspective view of a pin and coupling bridge of the socket of FIG. 2A in accordance with some embodiments.

FIG. 3 illustrates a perspective view of another pin and coupling bridge in accordance with some embodiments.

FIG. 4 illustrates a perspective view of another socket in accordance with some embodiments.

FIG. 5A illustrates a top and side view of a socket in accordance with some embodiments.

FIG. 5B illustrates a top and side view of another socket in accordance with some embodiments.

FIG. 5C illustrates a top and side view of another socket in accordance with some embodiments.

FIG. 5D illustrates return loss at pin 5 of the sockets in FIGS. 5A-5C in accordance with some embodiments.

FIG. 5E illustrates insertion loss at pin 5 of the sockets in FIGS. 5A-5C in accordance with some embodiments.

FIG. 5F illustrates far end crosstalk (FEXT) at pin 5 of the sockets in FIGS. 5A-5C in accordance with some embodiments.

FIG. 6A illustrates a top and side view of another socket in accordance with some embodiments.

FIG. 6B illustrates a top and side view of another socket in accordance with some embodiments.

FIG. 6C illustrates return loss at pin 5 of the sockets in FIGS. 6A-6B in accordance with some embodiments.

FIG. 6D illustrates insertion loss at pin 5 of the sockets in FIGS. 6A-6B in accordance with some embodiments.

FIG. 6E illustrates FEXT at pin 5 of the sockets in FIGS. 6A-6B in accordance with some embodiments.

FIG. 7 illustrates a side view of a contact housing in accordance with some embodiments.

FIG. 8A illustrates a side view of another contact housing in accordance with some embodiments.

FIG. 8B illustrates a top view of the contact housing of FIG. 8A in accordance with some embodiments.

FIG. 9A illustrates a perspective view of a pin and bridge arrangement in accordance with some embodiments.

FIG. 9B illustrates a side view of the pin and bridge arrangement of FIG. 9A in accordance with some embodiments.

FIG. 10 illustrates a side view of a PCB in accordance with some embodiments.

FIG. 11 illustrates a method of providing a socket according to some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

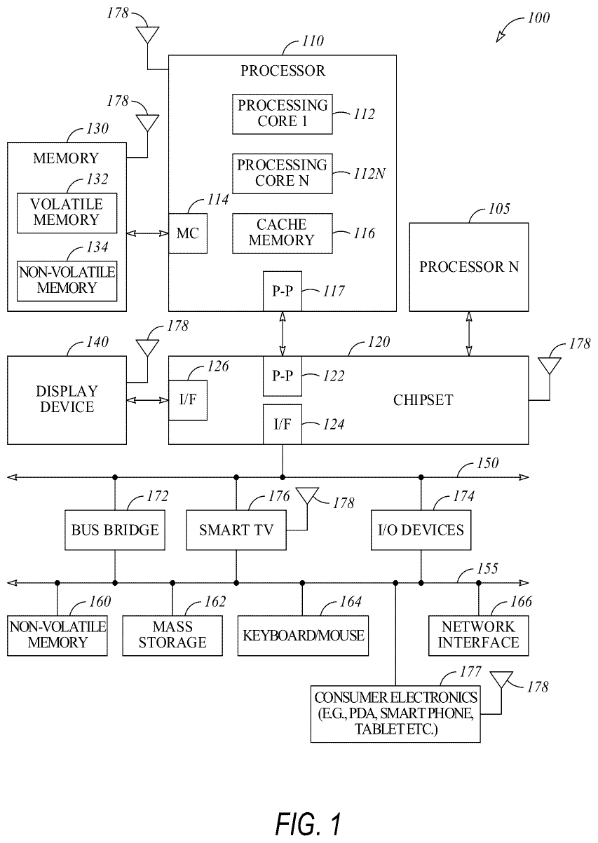

FIG. 1 illustrates a system level diagram, depicting an example of an electronic device (e.g., system) that may include a processor and socket and/or methods described herein. In one embodiment, system 100 includes, but is not limited to, a desktop computer, a laptop computer, a netbook, a tablet, a notebook computer, a personal digital assistant (PDA), a server, a workstation, a cellular telephone, a mobile computing device, a smart phone, an Internet appliance or any other type of computing device. In some embodiments, system 100 includes a system on a chip (SOC) system.

In one embodiment, processor 110 has one or more processor cores 112 and 112N, where 112N represents the Nth processor core inside processor 110 where N is a positive integer. In one embodiment, system 100 includes multiple processors including processor 110 and processor 105, where processor 105 has logic similar or identical to the logic of processor 110. In some embodiments, processing core 112 includes, but is not limited to, pre-fetch logic to fetch instructions, decode logic to decode the instructions, execution logic to execute instructions and the like. In some embodiments, processor 110 has a cache memory 116 to cache instructions and/or data for system 100. Cache memory 116 may be organized into a hierarchal structure including one or more levels of cache memory.

In some embodiments, processor 110 includes a memory controller 114, which is operable to perform functions that enable the processor 110 to access and communicate with memory 130 that includes a volatile memory 132 and/or a non-volatile memory 134. In some embodiments, processor 110 is coupled with memory 130 and chipset 120. Processor 110 may also be coupled to a wireless antenna 178 to communicate with any device configured to transmit and/or receive wireless signals. In one embodiment, an interface for wireless antenna 178 operates in accordance with, but is not limited to, the IEEE 802.11 standard and its related family, Home Plug AV (HPAV), Ultra Wide Band (UWB), Bluetooth, WiMax, or any form of wireless communication protocol.

In some embodiments, volatile memory 132 includes, but is not limited to, Synchronous Dynamic Random Access Memory (SDRAM), Dynamic Random Access Memory (DRAM), RAMBUS Dynamic Random Access Memory (RDRAM), and/or any other type of random access memory device. Non-volatile memory 134 includes, but is not limited to, flash memory, phase change memory (PCM), read-only memory (ROM), electrically erasable programmable read-only memory (EEPROM), or any other type of non-volatile memory device.

Memory 130 stores information and instructions to be executed by processor 110. In one embodiment, memory 130 may also store temporary variables or other intermediate information while processor 110 is executing instructions. In the illustrated embodiment, chipset 120 connects with processor 110 via Point-to-Point (PtP or P-P) interfaces 117 and 122. Chipset 120 enables processor 110 to connect to other elements in system 100. In some embodiments of the example system, interfaces 117 and 122 operate in accordance with a PtP communication protocol such as the Intel® QuickPath Interconnect (QPI) or the like. In other embodiments, a different interconnect may be used.

In some embodiments, chipset 120 is operable to communicate with processor 110, 105N, display 140, and other devices, including a bus bridge 172, a smart TV 176, I/O devices 174, nonvolatile memory 160, a storage medium (such as one or more mass storage devices) 162, a keyboard/mouse 164, a network interface 166, and various forms of consumer electronics 177 (such as a PDA, smart phone, tablet etc.), etc. In one embodiment, chipset 120 couples with these devices through an interface 124. Chipset 120 may also be coupled to a wireless antenna 178 to communicate with any device configured to transmit and/or receive wireless signals. In one example, any combination of components in a chipset may be separated by a continuous flexible shield as described in the present disclosure.

Chipset 120 connects to display 140 via interface 126. Display 140 may be, for example, a liquid crystal display (LCD), a light emitting diode (LED) array, an organic light emitting diode (OLED) array, or any other form of visual display device. In some embodiments of the example system, processor 110 and chipset 120 are merged into a single SOC. In addition, chipset 120 connects to one or more buses 150 and 155 that interconnect various system elements, such as I/O devices 174, nonvolatile memory 160, mass storage device 162, a keyboard/mouse 164, and network interface 166. Buses 150 and 155 may be interconnected together via a bus bridge 172.

In one embodiment, mass storage device 162 includes, but is not limited to, a solid state drive, a hard disk drive, a universal serial bus flash memory drive, or any other form of computer data storage medium. In one embodiment, network interface 166 is implemented by any type of well-known network interface standard including, but not limited to, an Ethernet interface, a universal serial bus (USB) interface, a Peripheral Component Interconnect (PCI) Express interface, a wireless interface and/or any other suitable type of interface. In one embodiment, the wireless interface operates in accordance with, but is not limited to, the IEEE 802.11 standard and its related family, Home Plug AV (HPAV), Ultra Wide Band (UWB), Bluetooth, WiMax, or any form of wireless communication protocol.

While the modules shown in FIG. 1 are depicted as separate blocks within the system 100, the functions performed by some of these blocks may be integrated within a single semiconductor circuit or may be implemented using two or more separate integrated circuits. For example, although cache memory 116 is depicted as a separate block within processor 110, cache memory 116 (or selected aspects of 116) can be incorporated into processor core 112.

To better illustrate the method and apparatuses disclosed herein, a non-limiting list of embodiments is provided here:

As above, sockets with homogenous pin arrangements have various design limitations. In particular, it is desirable to provide efficient coupling between two contacts (also referred to herein as pins or contact pins). However, there are mechanical limitations for fine pitch placement of pins—including fabrication limitations. To overcome this, a metal structure, that may be described as “stub-like”, referred to herein generally as a coupling bridge, may be provided in the socket to enhance electromagnetic (EM) coupling between targeted contact pin pairs. The coupling bridge may be electro-conductively coupled to one pin but insulated from the other pin to avoid shorting between the pins. The coupling bridges may be selectively provided to specific pins (i.e., a subset of the set of pins in the socket) by strategically positioning the coupling bridges within the socket. A printed circuit board (PCB)-like manufacturing process may be used as part of the socket housing to achieve fine pitch 3D metal features as the coupling bridge. Here, the term fine pitch is a line width of less than about 50 μm and a line spacing of less than about 100 μm. Use of the coupling bridge may permit fine tuning of the impedance, and enhancement of mutual coupling between the coupled pins, thereby reducing the reflection and the FEXT from neighbor signals, without redesigning the pinout layout.

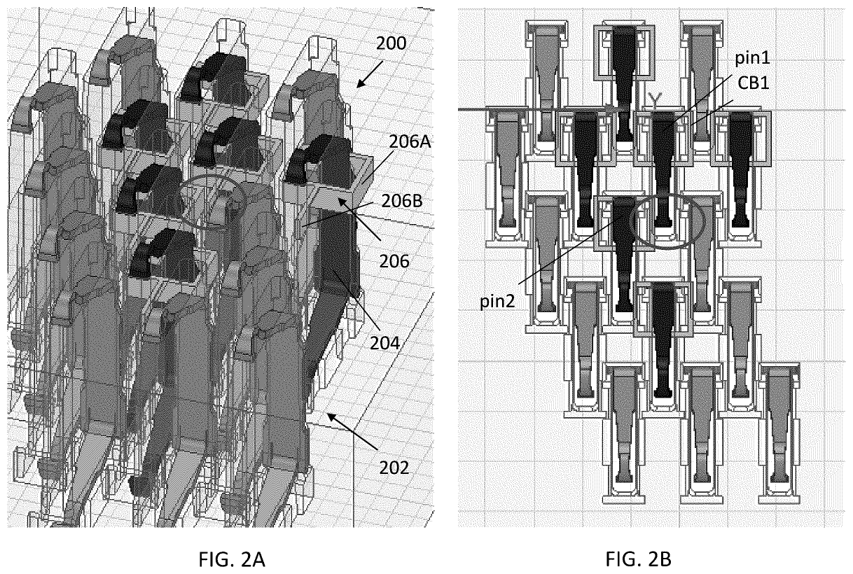

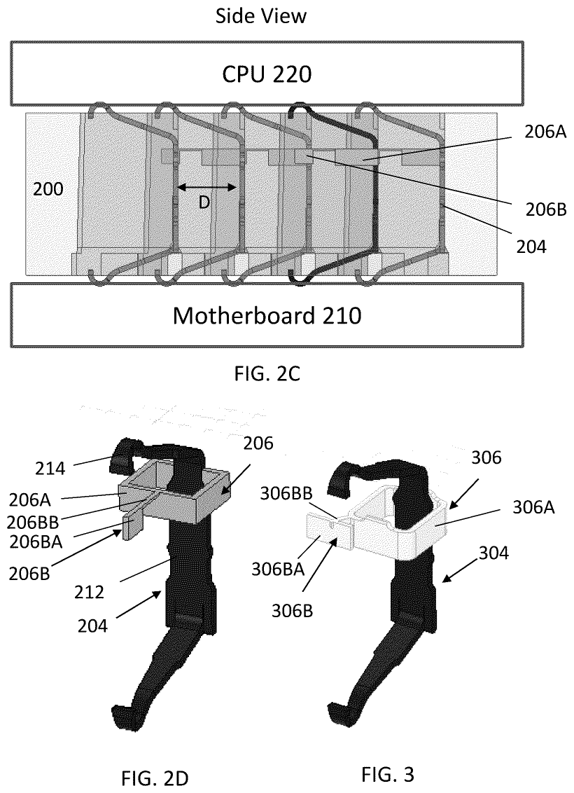

FIG. 2A illustrates a perspective view of a socket in accordance with some embodiments. FIG. 2B illustrates a top view of the socket of FIG. 2A in accordance with some embodiments. FIG. 2C illustrates a side view of the socket of FIG. 2A in accordance with some embodiments. FIG. 2D illustrates a perspective view of a pin and coupling bridge of the socket of FIG. 2A in accordance with some embodiments. The socket 200 may be configured to support DDR Gen5 or Gen6, for example. As shown, the socket 200 contains a pin arrangement 202 that has a plurality of individual pins 204 arranged in a regular formation. The pins 204 are arranged in rows and have a predetermined distance D between each pin 204, which may be, for example, 0.9 mm from tip to tip. The pins 204 of adjacent rows are laterally offset by one half the distance between adjacent pins 204 of each row (thus, the pins 204 of every 2 rows are aligned). The pin arrangement 202 may be configured to permit the socket 200 to operate at speeds of 16 GT/s for DDR6.

The pins 204 may be coupled to form pin pairs that include one pin 204 carrying a positive signal and the other pin 204 carrying a corresponding negative signal (i.e., each of the pins 204 is arranged to carry a differential portion of the same signal). The pin pairs may be DDR pairs, although single ended pins may also be used in the socket 200 other embodiments. The pins 204 may be in adjacent (or different) rows and thus may contain (in some orientations) a front pin and a rear pin. The DDR pins 204 may carry data signals and thus be, for example, data (DQ) pins. Note that the use of DDR herein is used to indicate any DDR generation. All the pins 204 in the socket 200 have a uniform pin shape and orientation in some embodiments. The socket 200 has a socket body that may be designed to accept a connection with CPU, for example. The pins 204 are formed from a flexible conductive material, such as metal (such as aluminum (Al)) and may have any shape to connect to the device package.

Each pin 204, as depicted in FIG. 2D, has a main body 212, as well as one or opposing contact portions 214. The contact portions 214 are cantilevered and extend from the main body 212 at an obtuse angle from the main body 212, having hooks for pressure contact to corresponding contacts of a PCB (motherboard) 210 and a processor (such as a CPU) 220. Note that while a CPU is indicated herein, other types of chips or electronic devices may be connected to the pins 204 of the socket 200. The contact between the pins 204 and each of the motherboard 210 and the CPU 220 are pressure contacts, some or all of which may be used to provide signals between the motherboard 210 and the CPU 220. In other embodiments, the pins 204 of the socket 200 may be soldered or otherwise connected to the motherboard 210 through a non-pressure contact while the CPU 220 is inserted into or otherwise physically and electrically connected to the socket 200. Thus, the socket 200 provides data and/or control signals between the motherboard 210 and the CPU 220.

The socket 200 includes multiple metallic structures or coupling bridges 206. Each coupling bridge 206 is connected to a different one of the pins 204 of the socket 200. As is apparent in FIG. 2B, pin 1 contains a coupling bridge CB that extends towards pin2 to enhance coupling between pin1 and pin2. As shown, not all of the pin pairs are electromagnetically coupled together: that is, at least some of the pin pairs are isolated from each other. The coupling bridge 206 includes two metallic portions, a first, substantially ring-shaped, portion 206a and a second, coupling, or stub portion 206b that extends essentially perpendicularly from the ring-shaped portion 206a. The ring-shaped portion 206a is physically coupled to the main body 212 of the pin 204 and extends substantially symmetrically laterally from the back or side of the main body 212 of the pin 204 to form a ring shape having a portion farthest from the main body 212 of the pin 204 that opposes the front of the main body 212 of the pin 204. The ring-shaped portion 206a may thus partially or entirely surround the pin 204 and may have any shape (e.g., substantially rectangular as shown in the figures herein).

The stub portion 206b extends perpendicularly from a center of the portion of the ring-shaped portion 206a opposing the front of the main body 212 of the pin 204 (as above the coupling bridge CB of pin 1 extends towards pin2). The stub portion 206b has an overall substantial flag (or “L”) shape, with a stub 206ba extending from an extension portion 206bb. The stub 206ba has a width that is similar (75% or greater) or identical to that of the ring-shaped portion 206a. The extension portion 206bb is a relatively thin (compared to the stub 206ba—10-20% of the width) connector that is physically coupled to the ring-shaped portion 206a. The stub 206ba is disposed adjacent to the ring-shaped portion 206a of a pin 204 in an adjacent row. Specifically, as the pin 204 may be a DDR pair (a pair of pins carrying a DDR signal), the stub 206bacouples to a side of the ring-shaped portion 206a of the other pin 204 of the DDR pair. The stub 206ba has a substantially rectangular shape (within the tolerance of fabricating the stub 206ba): the area of the stub 206ba can be determined dependent on the amount of coupling desired between the DDR pair. In some cases, the stub 206ba may be symmetrically disposed between the ring-shaped portions 206a of adjacent pins 204 in the adjacent row. The pins 204 and coupling bridge 206 may be formed from the same metal or may be formed from different metals, which may be physically connected by force alone or using a conductive adhesive (such as solder or paste).

FIG. 3 illustrates a perspective view of another pin and coupling bridge in accordance with some embodiments. The socket and pin arrangement of the pin 304 shown in FIG. 3 is the same as that shown in FIGS. 2A-2C. The pin 304 is similar to the pin 204 in FIGS. 2A-2D. Each coupling bridge 306 is connected to a different one of the pins 304 of the socket. The coupling bridge 306 includes two portions, a substantially ring-shaped portion 306a and a stub portion 306b that extends essentially perpendicularly from the ring-shaped portion 306a. The ring-shaped portion 306a is physically coupled to the main body of the pin 304 and extends substantially symmetrically laterally from the back or side of the main body of the pin 304 to form a ring shape having a portion farthest from the main body of the pin 304 that opposes the front of the main body of the pin 304.

However, unlike the coupling bridge 206 of FIGS. 2A-2D, the stub portion 306b of FIG. 3 extends perpendicularly from (or proximate to) a corner of the portion of the ring-shaped portion 306a opposing the front of the main body of the pin 304. The stub portion 306b has an overall substantial “T” shape or “L” shape, with a stub 306ba extending from an extension portion 306bb and has a width that is similar or identical to the ring-shaped portion 306a. The extension portion 306bb is a thin connector that is physically coupled to the ring-shaped portion 306a. The stub 306ba is disposed adjacent to the ring-shaped portion 306a of a pin 304 in an adjacent row. Specifically, as the pin 304 may be a DDR pair (a pair of pins carrying a DDR signal), the stub 306bacouples to the back of the ring-shaped portion 306a of the other pin 304 of the DDR pair (which is closest to the pin 304). The stub 306ba has a substantially rectangular shape: the area of the stub 306ba can be determined dependent on the amount of coupling desired between the DDR pair. Unlike the stub 206ba of FIGS. 2A-2D, as the stub 306ba in FIG. 3 is offset from the center of the ring-shaped portion 306a, the stub 306ba is only disposed to couple to one of the two pins 304 in the adjacent row. The size of the stub 306ba and/or the proximity of the stub 306ba to the other pin 304 of the DDR pair may be adjusted dependent on the amount of coupling desired. The stub 306ba may electromagnetically couple to the ring-shaped portion 306a of the other pin 204 or may electromagnetically couple directly to the other pin 204 if no ring-shaped portion 306a is present at the other pin 204.

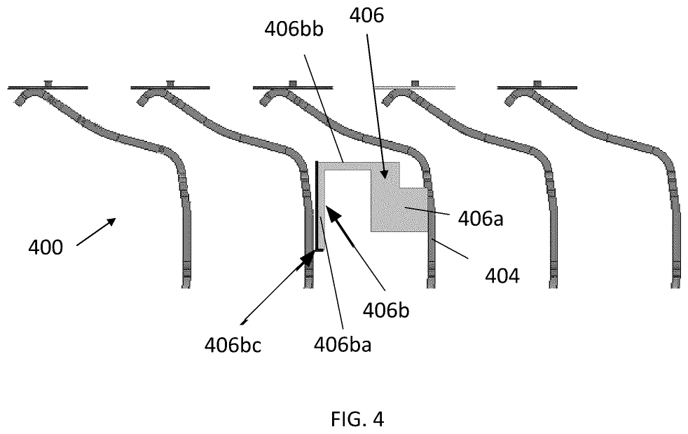

FIG. 4 illustrates a perspective view of another pin and coupling bridge in accordance with some embodiments. The socket 400 and pin arrangement of the pin 404 shown in FIG. 4 is the same as that shown in FIGS. 2A-2C. The pin 404 is similar to the pin 204 in FIGS. 2A-2D. Each coupling bridge 406 is connected to a different one of the pins 404 of the socket 400. The coupling bridge 406 includes two portions, a substantially ring-shaped portion 406a and a stub portion 406b that extends essentially perpendicularly from the ring-shaped portion 406a. The ring-shaped portion 406a is physically coupled to the main body of the pin 404 and extends substantially symmetrically laterally from the back or side of the main body of the pin 404 to form a ring shape having a portion farthest from the main body of the pin 404 that opposes the front of the main body of the pin 404.

Like the coupling bridge 306 of FIG. 3, the stub portion 406b of FIG. 4 extends perpendicularly from (or proximate to) a corner of the portion of the ring-shaped portion 406a opposing the front of the main body of the pin 404. The stub portion 406b has an overall substantial “T” shape or “L” shape, with a stub 406ba extending from an extension portion 406bb. The extension portion 406bb is a thin connector that is physically coupled to the ring-shaped portion 406a. The stub 406ba is disposed adjacent to the ring-shaped portion 406a of a pin 404 in an adjacent row. Specifically, as the pin 404 may be a DDR pair, the stub 406ba couples to the back of the ring-shaped portion 406a of the other pin 404 of the DDR pair. The stub 406ba has a substantially rectangular shape: the area of the stub 406ba can be determined dependent on the amount of coupling desired between the DDR pair. The stub 406ba has an insulating film 406bc covering the surface facing the other pin 404 of the DDR pair. Thus, the stub 406ba in FIG. 4 may be disposed closer to compared to the stub 306ba of FIG. 3 the other pin 404 of the DDR pair, or in some embodiments may even contact the other pin 404 of the DDR pair unlike the stub 306ba of FIG. 3 as the insulating film 406bc prevents shorting between the pins 404 of the DDR pair. In addition to, or instead of, the area of the stub 406ba, the thickness of the insulating film 406bc may also be adjusted to obtain the desired amount of coupling between the pins 404 of the DDR pair. The insulating film 406bc may be, for example, around 50 microns, although this may vary dependent on the desired coupling.

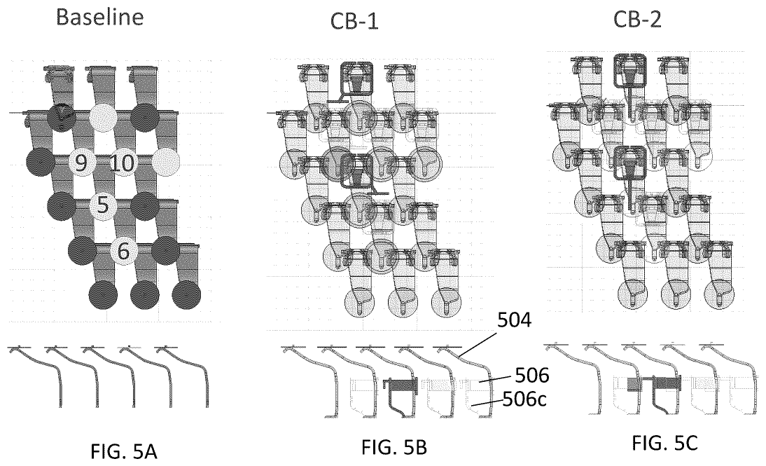

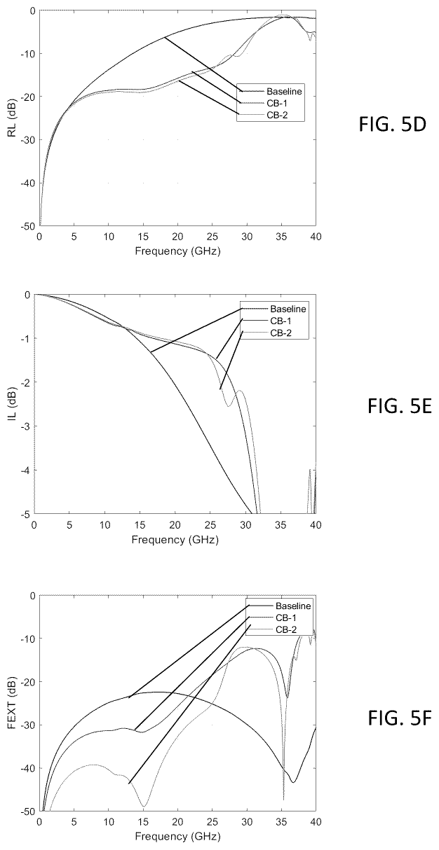

FIG. 5A illustrates a top and side view of a socket in accordance with some embodiments. FIG. 5B illustrates a top and side view of another socket in accordance with some embodiments. FIG. 5C illustrates a top and side view of another socket in accordance with some embodiments. FIG. 5D illustrates return loss at pin 5 of the sockets in FIGS. 5A-5C in accordance with some embodiments. FIG. 5E illustrates insertion loss at pin 5 of the sockets in FIGS. 5A-5C in accordance with some embodiments. FIG. 5F illustrates FEXT at pin 5 of the sockets in FIGS. 5A-5C in accordance with some embodiments. FIGS. 5D-5F show simulations of high speed I/O (HSIO) measurements for a Land Grid Array (LGA) and Ball Grid Array (BGA) arrangement at pin 5 indicated in FIG. 5A. A LGA is a package with pins on the socket instead of the integrated circuit and a BGA is a package that uses pads with solder balls. As shown in FIGS. 5B and 5C, CB-1 corresponds to the embodiment shown in FIG. 3, CB-2 corresponds to the embodiment shown in FIGS. 2A-2D. In addition, for a BGA structure shown in the side views of FIGS. 5B and 5C, the coupling bridge 506 may have a tail 506c that extends from proximate the end of the coupling bridge closest to the other pin 504 to a lower portion of the pin 504. The tail 506c of the coupling bridge 506 is coupled to one end of the pin 504 via solder (not shown), which may also be used to connect to an underlying electronic substrate (not shown), such as a PCB or interposer, for example. As can be seen, both the return and insertion loss decrease with increasing frequency from about 5 GHz (return loss) or about 12 GHz (insertion loss) for each of the CB-1 and CB-2 arrangement compared with the baseband, and a FEXT improvement at frequencies less than between about 20 and 25 GHz.

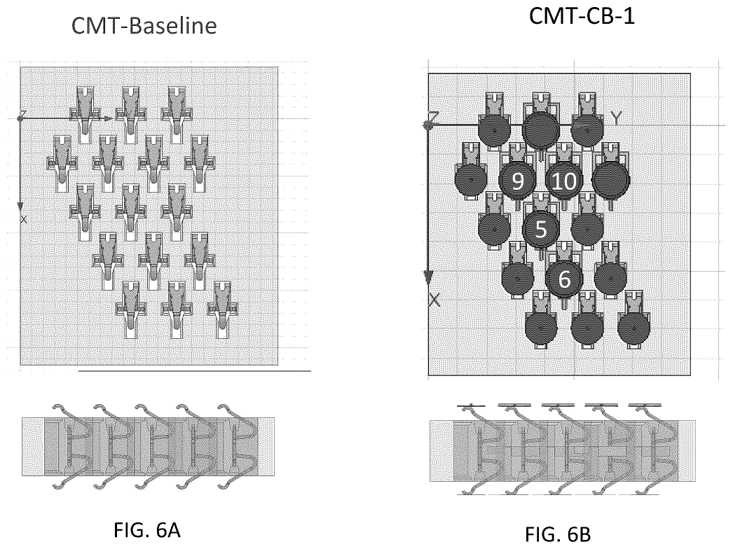

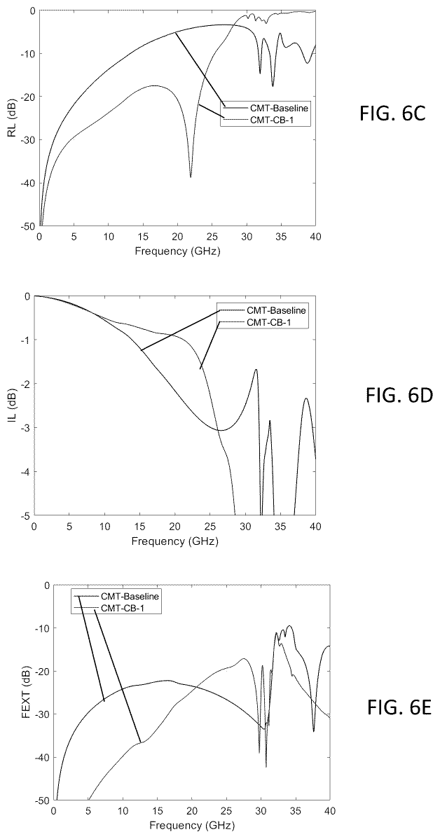

FIG. 6A illustrates a top and side view of another socket in accordance with some embodiments. FIG. 6B illustrates a top and side view of another socket in accordance with some embodiments. FIG. 6C illustrates return loss at pin 5 of the sockets in FIGS. 6A-6B in accordance with some embodiments. FIG. 6D illustrates insertion loss at pin 5 of the sockets in FIGS. 6A-6B in accordance with some embodiments. FIG. 6E illustrates FEXT at pin 5 of the sockets in FIGS. 6A-6B in accordance with some embodiments. FIGS. 6C-6E show simulations of high speed I/O (HSIO) measurements for a Compression Mount Technology (CMT) arrangement. While the pin is somewhat different from that shown in other arrangements, the contact mechanism is the same as that shown in FIGS. 2A-2D. CMT-CB-1 corresponds to the embodiment shown in FIGS. 2A-2D. As can be seen, there is return loss improvement for the CB-1 arrangement, insertion loss improvement from about 10 to about 25 GHZ, and a FEXT improvement at frequencies less than about 20 GHz compared with the baseband.

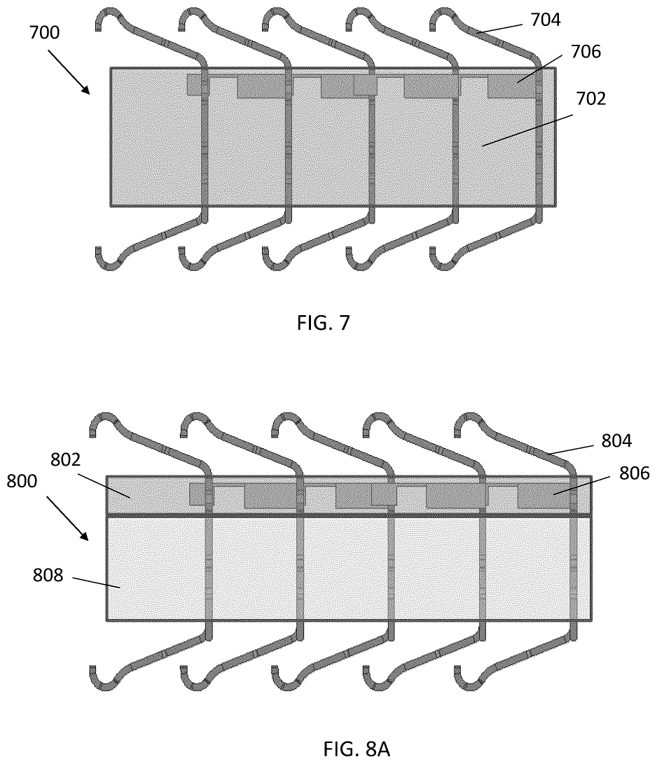

FIG. 7 illustrates a side view of a contact housing in accordance with some embodiments. As shown in FIG. 7, the contact housing 700 (also referred to as the socket body) can be manufactured using a PCB 702. The pins 704 may extend from vias in the PCB 702 and may be configured to couple to a motherboard and CPU (not shown) using pressure sensitive contacts, similar to the arrangement shown in FIGS. 2A-2D. The metal coupling bridge 706 is part of one of the metal layers of the PCB 702, and thus may be formed during fabrication of the PCB 702. Note that although the coupling bridge 706 is shown as being disposed proximate to the top of the PCB 702, in other embodiments the coupling bridge 706 may be disposed at other locations (e.g., in the middle) of the PCB 702. Although the coupling bridge 706 shown in FIG. 7 is similar to that of FIGS. 2A-2D, other embodiments may use the coupling bridge of FIG. 3 or 4.

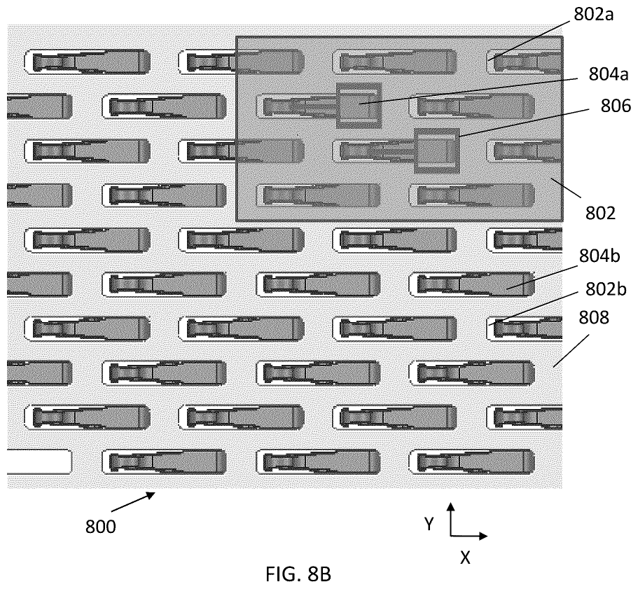

FIG. 8A illustrates a side view of another contact housing in accordance with some embodiments. FIG. 8B illustrates a top view of the contact housing of FIG. 8A in accordance with some embodiments. Similar to FIG. 7, in FIG. 8A, the contact housing 800 can be manufactured using a PCB 802. However, in FIG. 8A, the contact housing 800 further contains a liquid crystal polymer (LCP)-based housing 808. The LCP-based housing 808 may be formed using a thermoplastic resin. As shown in FIG. 8B, the pins 804a may extend from vias 802a in the PCB 804 and vias 802b in the LCP-based housing 808. The pins 804a may be configured to couple to a motherboard and CPU (not shown) using pressure sensitive contacts, similar to the arrangement shown in FIGS. 2A-2D. Similarly, the pins 804b (which are not connected to a coupling bridge 806) may extend from the vias 802b in the LCP-based housing 808 and may be configured to couple to a motherboard and CPU using pressure sensitive contacts. The use of a separate PCB 802 with the LCP-based housing 808 permits the coupling bridge 806 to be placed selectively along the X-Y direction as shown in FIG. 8B, with the PCB 802 being coupled to the LCP-based housing 808 using an adhesive.

The metal coupling bridge 806 is part of one of the metal layers of the PCB 802, and thus may be formed during fabrication of the PCB 802. As above, the metal coupling bridge 806 may be formed in any shape, with the area and positioning selected to provide a desired amount of coupling between DDR pin pairs. Note that although the coupling bridge 806 is shown in FIG. 8A as being disposed proximate to the top of the PCB 802, in other embodiments the coupling bridge 806 may be disposed at other locations (e.g., in the middle) of the PCB 802. Although the coupling bridge 806 shown in FIGS. 8A and 8B is similar to that of FIGS. 2A-2D, other embodiments may use the coupling bridge of FIG. 3 or 4.

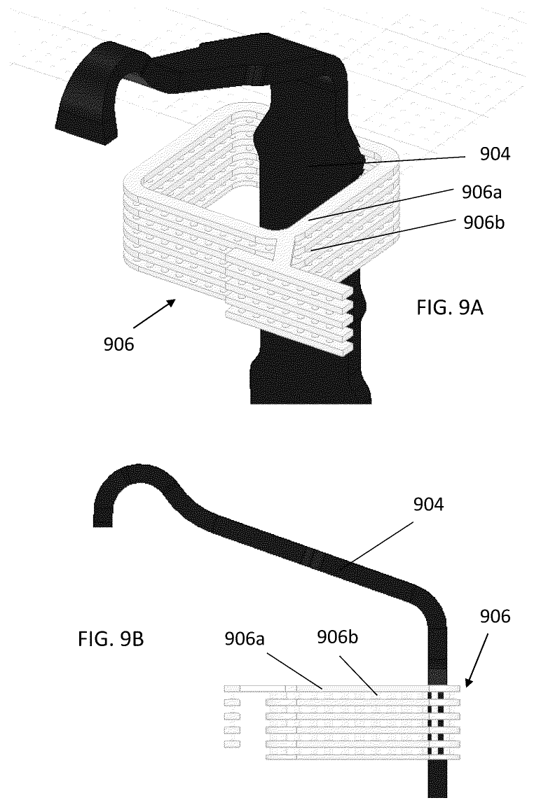

FIG. 9A illustrates a perspective view of a pin and bridge arrangement in accordance with some embodiments. FIG. 9B illustrates a side view of the pin and bridge arrangement of FIG. 9A in accordance with some embodiments. The embodiment shown in FIGS. 9A and 9B shows a pin 904 and a coupling bridge 906. The coupling bridge 906 is fabricated using traces on one or more metal (e.g., copper (Cu)) layers of a PCB. When formed using multiple metal layers, the traces are connected using multiple vias 906b throughout each layer to connect traces on adjacent layers together. This permits a desired coupling bridge thickness to be achieved by a combination of multi-layer traces 906a connected by the vertical vias 906b. Although the coupling bridge 906 shown in FIGS. 9A and 9B is similar to that of FIG. 3, other embodiments such as the coupling bridge shown in FIGS. 2A-2D or 4 may be implemented using the PCB.

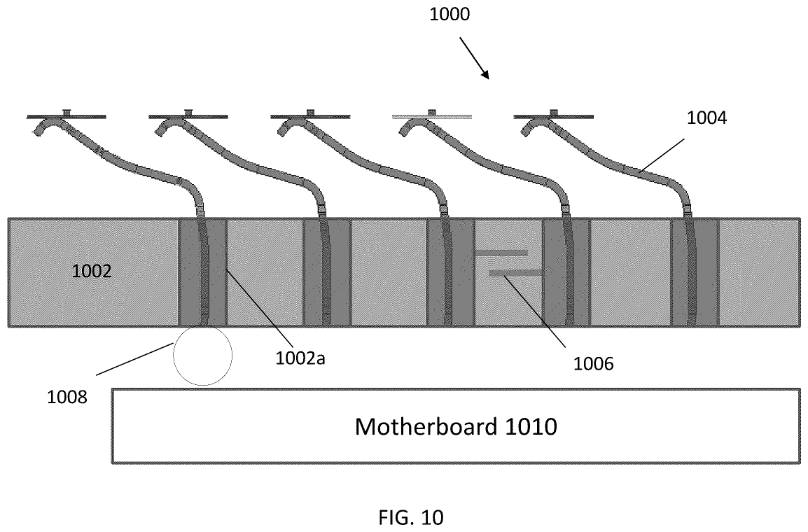

FIG. 10 illustrates a side view of a PCB in accordance with some embodiments. The arrangement 1000 shown in FIG. 10 shows a PCB 1002 having multiple vias 1002a through which pins 1004 extend. The pins 1004 are connected through solder balls 1008 to traces on a motherboard 1010. A coupling bridge 1006 is formed from overlapping traces in the PCB 1002 that extend from the sidewalls of a pair of adjacent vias 1002a through which the DDR pair pins extend. As in other embodiments, the coupling bridge 1006 may be formed in any shape, with the area and distance between the traces selected to provide a desired amount of coupling between DDR pin pairs. In addition, as in the other embodiments herein, although the DDR pin pairs are described as being adjacent, the pins may be disposed farther away from each other by extending the traces on the PCB (or extension portion in the socket).

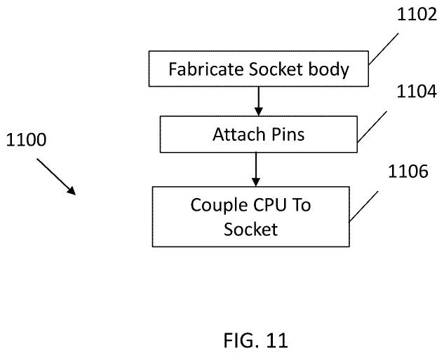

FIG. 11 illustrates a method of providing a socket according to some embodiments. The method 1100 is show as an example only: additional operations may be present and/or one or more of the operations herein may be combined. The method 1100 of FIG. 11 may provide operations related to the pin arrangement for high speed (defined as DDR Gen 5.0 or greater: greater than about 4 GB/s throughput for a xl slot) I/O interactions on a motherboard, such as for a CPU: additional operations may be present, including operations related to fabricating PCIe and/or DIMMs slots, as well as attaching various components to the motherboard. At operation 1102, a socket body is fabricated. The socket may be a SMT-LGA Socket, CMT-LGA Socket, or PCB housing based-LGA socket such as those described herein. The socket body has a vias for pins and a coupling bridge configured to couple at least one pair of pins. The coupling bridge may be formed in any of the arrangements described herein, among others.

At operation 1104, pins are attached to the socket body to form the socket. Some or all of the pins may be coupled in pairs using a coupling bridge for each pair. The pins may be compression-based contact and/or solder contact (or otherwise attached) on one or both ends of the pins to different components.

After the socket has been completed at operation 1104 and perhaps attached via solder mounting to a motherboard, a CPU or other device can be coupled to the pins at operation 1106.

### EXAMPLES

Example 1 is an apparatus for a socket, the apparatus comprising: a socket body: a plurality of pins attached to the socket body, wherein the plurality of pins includes, a first pin and a second pin adjacent to the first pin: and a metallic structure conductively coupled to the first pin and extending towards the second pin.

In Example 2, the subject matter of Example 1 includes, wherein the metallic structure includes: a ring-shaped portion that at least partially surrounds the first pin, and a stub portion extending from the ring-shaped portion, the stub portion configured to electromagnetically couple the first pin to the second pin.

In Example 3, the subject matter of Example 2 includes, wherein the stub portion includes: a stub that electromagnetically couples the first pin to the second pin, and an extension portion that connects the ring-shaped portion and the stub.

In Example 4, the subject matter of Example 3 includes, wherein: the stub portion extends from substantially a center of the ring-shaped portion, the stub is substantially rectangular, has a width that is at least similar or identical to that of the ring-shaped portion, and extends in a direction of extension of the coupling portion from the ring-shaped portion, and the extension portion is a thinner connector compared to the coupler.

In Example 5, the subject matter of Example 4 includes, wherein the stub electromagnetically couples the first pin to a ring-shaped portion of a coupling bridge of the second pin, the ring-shaped portion of the second pin at least partially surrounding the second pin.

In Example 6, the subject matter of Examples 3-5 includes, wherein: the stub portion extends from substantially a corner of the ring-shaped portion and forms a substantial “T” shape or “L” shape, and the stub is substantially rectangular, has a width that is at least similar to that of the ring-shaped portion, and extends in a direction perpendicular to a direction of extension of the stub portion from the ring-shaped portion.

In Example 7, the subject matter of Examples 3-6 includes, wherein: the stub portion extends from the ring-shaped portion to form a substantial “T” shape or “L” shape, and the stub is substantially rectangular, extends in a direction perpendicular to a direction of extension of the stub portion from the ring-shaped portion, and has an insulating film disposed thereon that contacts the second pin.

In Example 8, the subject matter of Examples 3-7 includes, wherein: one end of each of the first pin and second pin is configured to connect to an electronic substrate, the stub portion further comprises a tail that extends from the stub, and the stub is soldered to the one end of the first pin.

In Example 9, the subject matter of Examples 1-8 includes, wherein: a printed circuit board (PCB) forms the socket body, the metallic structure is formed from conductive traces on multiple layers of the PCB, the conductive trace of each layer connected at multiple locations to the conductive trace of an adjacent layer through vias, and ends of the pins extend from the PCB.

In Example 10, the subject matter of Examples 1-9 includes, wherein: the socket body is formed from a printed circuit board (PCB) and a liquid crystal polymer (LCP)-based housing, the PCB is disposed on at least a portion of the LCP-based housing, and the metallic structure is formed from conductive traces on multiple layers of the PCB, the conductive trace of each layer connected at multiple locations to the conductive trace of an adjacent layer through vias.

In Example 11, the subject matter of Example 10 includes, wherein: the PCB is disposed over only the portion of the LCP-based housing, and for pins that extend through the PCB and the portion of the LCP-based housing: one end of the pins extends from the PCB and another end of the pins extends from the portion of the LCP-based housing.

Example 12 is a system for transmitting signals between electronic devices, the system comprising: a socket comprising: a socket body that contains a plurality of coupling bridges formed therein, each coupling bridge having a first portion and a second portion extending from the first portion; and a pin arrangement attached to the socket body, the pin arrangement including a first set of pin pairs and a second set of pin pairs, pins of each pin pair of the first set of pin pairs electromagnetically coupled together by the second portion of a different coupling bridge, pins of each pin pair of the second set of pin pairs isolated from each other.

In Example 13, the subject matter of Example 12 includes, wherein for each pin pair of the first set of pin pairs: the first portion of the coupling bridge of the first pin is connected to and at least partially surrounds a first pin of the pin pair, and the second portion of the coupling bridge of the first pin comprises: a stub that electromagnetically couples the first pin to a second pin of the pin pair, and an extension portion that connects the first portion and the stub.

In Example 14, the subject matter of Example 13 includes, wherein: the second portion extends from substantially a center of the first portion, and the stub extends in a direction of extension of the second portion from the first portion and couples the first pin to a first portion of a coupling bridge of the second pin.

In Example 15, the subject matter of Examples 13-14 includes, wherein: the second portion of the coupling bridge of the first pin extends from substantially a corner of the first portion and forms a substantial “T” shape or “L” shape, and the stub extends in a direction perpendicular to a direction of extension of the second portion from the first portion.

In Example 16, the subject matter of Examples 13-15 includes, wherein: the second portion of the coupling bridge of the first pin extends from the first portion to form a substantial “T” shape or “L” shape, and the stub extends in a direction perpendicular to a direction of extension of the second portion from the first portion and has an insulating film disposed thereon that contacts the second pin.

In Example 17, the subject matter of Examples 12-16 includes, wherein: a printed circuit board (PCB) forms the socket body, the coupling bridge is formed from conductive traces on multiple layers of the PCB, the conductive trace of each layer connected at multiple locations to the conductive trace of an adjacent layer through vias, and ends of the pins of each pin pair of the first set of pin pairs and each pin pair of the second set of pin pairs extend from the PCB.

In Example 18, the subject matter of Examples 12-17 includes, wherein: the socket body is formed from a printed circuit board (PCB) and a liquid crystal polymer (LCP)-based housing, the PCB is disposed on at least a portion of the LCP-based housing, and the coupling bridge is formed from conductive traces on multiple layers of the PCB, the conductive trace of each layer connected at multiple locations to the conductive trace of an adjacent layer through vias.

Example 19 is a method of fabricating a socket, the method comprising: providing a socket body that contains a plurality of coupling bridges therein, each coupling bridge containing: a surrounding portion that at least partially surrounds a via, and a stub portion extending from the surrounding portion; and inserting pins into a plurality of vias, the pins arranged in pin pairs configured to support Double Data Rate (DDR) data signals, each first pin of at least some of the pin pairs electromagnetically coupled to a second pin of the at least some of the pin pairs using one of the coupling bridges.

In Example 20, the subject matter of Example 19 includes, wherein for each coupling bridge one of: the stub portion extends from substantially a center of the surrounding portion, a stub extends in a direction of extension of the stub portion from the surrounding portion, and the stub electromagnetically couples the first pin to a surrounding portion of a coupling bridge of the second pin, or the stub portion extends from substantially a corner of the surrounding portion and forms a substantial “T” shape or “L” shape, and the stub extends in a direction perpendicular to the direction of extension of the stub portion from the surrounding portion.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An apparatus for a socket, the apparatus comprising:
a socket body:
a plurality of pins attached to the socket body, wherein the plurality of pins includes a first pin and a second pin adjacent to the first pin; and
a metallic structure conductively coupled to the first pin and extending towards the second pin.

2. The apparatus of claim 1, wherein the metallic structure includes:
a ring-shaped portion that at least partially surrounds the first pin, and
a stub portion extending from the ring-shaped portion, the stub portion configured to electromagnetically couple the first pin to the second pin.

3. The apparatus of claim 2, wherein the stub portion includes:
a stub that electromagnetically couples the first pin to the second pin, and an extension portion that connects the ring-shaped portion and the stub.

4. The apparatus of claim 3, wherein:
the stub portion extends from substantially a center of the ring-shaped portion,
the stub is substantially rectangular, has a width that is at least similar or identical to that of the ring-shaped portion, and extends in a direction of extension of the coupling portion from the ring-shaped portion, and
the extension portion is a thinner connector compared to the coupler.

5. The apparatus of claim 4, wherein the stub electromagnetically couples the first pin to a ring-shaped portion of a coupling bridge of the second pin, the ring-shaped portion of the second pin at least partially surrounding the second pin.

6. The apparatus of claim 3, wherein:
the stub portion extends from substantially a corner of the ring-shaped portion and forms a substantial “T” shape or “L” shape, and
the stub is substantially rectangular, has a width that is at least similar to that of the ring-shaped portion, and extends in a direction perpendicular to a direction of extension of the stub portion from the ring-shaped portion.

7. The apparatus of claim 3, wherein:
the stub portion extends from the ring-shaped portion to form a substantial “T” shape or “L” shape, and
the stub is substantially rectangular, extends in a direction perpendicular to a direction of extension of the stub portion from the ring-shaped portion, and has an insulating film disposed thereon that contacts the second pin.

8. The apparatus of claim 3, wherein:
one end of each of the first pin and second pin is configured to connect to an electronic substrate,
the stub portion further comprises a tail that extends from the stub, and
the stub is soldered to the one end of the first pin.

9. The apparatus of claim 1, wherein:
a printed circuit board (PCB) forms the socket body,
the metallic structure is formed from conductive traces on multiple layers of the PCB, the conductive trace of each layer connected at multiple locations to the conductive trace of an adjacent layer through vias, and
ends of the pins extend from the PCB.

10. The apparatus of claim 1, wherein:
the socket body is formed from a printed circuit board (PCB) and a liquid crystal polymer (LCP)-based housing,
the PCB is disposed on at least a portion of the LCP-based housing, and
the metallic structure is formed from conductive traces on multiple layers of the PCB, the conductive trace of each layer connected at multiple locations to the conductive trace of an adjacent layer through vias.

11. The apparatus of claim 10, wherein:
the PCB is disposed over only the portion of the LCP-based housing, and
for pins that extend through the PCB and the portion of the LCP-based housing: one end of the pins extends from the PCB and another end of the pins extends from the portion of the LCP-based housing.

12. A system for transmitting signals between electronic devices, the system comprising:
a socket comprising:
a socket body that contains a plurality of coupling bridges formed therein, each coupling bridge having a first portion and a second portion extending from the first portion; and
a pin arrangement attached to the socket body, the pin arrangement including a first set of pin pairs and a second set of pin pairs, pins of each pin pair of the first set of pin pairs electromagnetically coupled together by the second portion of a different coupling bridge, pins of each pin pair of the second set of pin pairs isolated from each other.

13. The system of claim 12, wherein for each pin pair of the first set of pin pairs:
the first portion of the coupling bridge of the first pin is connected to and at least partially surrounds a first pin of the pin pair, and
the second portion of the coupling bridge of the first pin comprises:
a stub that electromagnetically couples the first pin to a second pin of the pin pair, and
an extension portion that connects the first portion and the stub.

14. The system of claim 13, wherein:
the second portion extends from substantially a center of the first portion, and
the stub extends in a direction of extension of the second portion from the first portion and couples the first pin to a first portion of a coupling bridge of the second pin.

15. The system of claim 13, wherein:
the second portion of the coupling bridge of the first pin extends from substantially a corner of the first portion and forms a substantial “T” shape or “L” shape, and
the stub extends in a direction perpendicular to a direction of extension of the second portion from the first portion.

16. The system of claim 13, wherein:
the second portion of the coupling bridge of the first pin extends from the first portion to form a substantial “T” shape or “L” shape, and
the stub extends in a direction perpendicular to a direction of extension of the second portion from the first portion and has an insulating film disposed thereon that contacts the second pin.

17. The system of claim 12, wherein:
a printed circuit board (PCB) forms the socket body,
the coupling bridge is formed from conductive traces on multiple layers of the PCB, the conductive trace of each layer connected at multiple locations to the conductive trace of an adjacent layer through vias, and
ends of the pins of each pin pair of the first set of pin pairs and each pin pair of the second set of pin pairs extend from the PCB.

18. The system of claim 12, wherein:
the socket body is formed from a printed circuit board (PCB) and a liquid crystal polymer (LCP)-based housing,
the PCB is disposed on at least a portion of the LCP-based housing, and
the coupling bridge is formed from conductive traces on multiple layers of the PCB, the conductive trace of each layer connected at multiple locations to the conductive trace of an adjacent layer through vias.

19. A method of fabricating a socket, the method comprising:
providing a socket body that contains a plurality of coupling bridges therein, each coupling bridge containing:
a surrounding portion that at least partially surrounds a via, and
a stub portion extending from the surrounding portion; and
inserting pins into a plurality of vias, the pins arranged in pin pairs configured to support Double Data Rate (DDR) data signals, each first pin of at least some of the pin pairs electromagnetically coupled to a second pin of the at least some of the pin pairs using one of the coupling bridges.

20. The method of claim 19, wherein for each coupling bridge one of:
the stub portion extends from substantially a center of the surrounding portion, a stub extends in a direction of extension of the stub portion from the surrounding portion, and the stub electromagnetically couples the first pin to a surrounding portion of a coupling bridge of the second pin, or
the stub portion extends from substantially a corner of the surrounding portion and forms a substantial “T” shape or “L” shape, and the stub extends in a direction perpendicular to the direction of extension of the stub portion from the surrounding portion.
